(19) United States
(12) Patent Application Publication
(10) Pub. No.: US 2024/0342644 A1
(43) Pub. Date: Oct. 17, 2024

(54) DEVICE FOR TREATING EXHAUST FUMES EMITTED BY A FUEL-CONSUMING APPARATUS

(71) Applicant: GAZTRANSPORT ET TECHNIGAZ, Saint Remy Les Chevreuse (FR)

(72) Inventors: Pavel BORISEVICH, Saint Remy Les Chevreuse (FR); Jaouad AMAICHAN, Saint Remy Les Chevreuse (FR); Charbel HOMSY, Saint Remy Les Chevreuse (FR)

(73) Assignee: GAZTRANSPORT ET TECHNIGAZ, Saint Remy Les Chevreuse (FR)

(21) Appl. No.: 18/580,064

(22) PCT Filed: Jul. 20, 2022
(86) PCT No.: PCT/FR2022/051443

§ 371 Date: Jan. 17, 2024

(30) Foreign Application Priority Data
Jul. 23, 2021 (FR) FR2107990

(51) Int. Cl. B01D 53/14; B01D 53/92; F01N 3/02; F02D 19/06

(52) U.S. Cl. CPC B01D 53/1475; B01D 53/1425; B01D 53/92; F01N 3/0205; F02D 19/0665; B01D 2257/504; B01D 2258/018; B01D 2259/4566

(57) ABSTRACT

A device for treating at least a portion of the exhaust fumes emitted by at least one fuel-consuming apparatus, the treatment device includes at least one compression member designed to raise a pressure of at least a portion of the exhaust fumes emitted by the fuel-consuming apparatus, and at least one unit for capturing carbon dioxide present in the exhaust fumes, the compression member and the unit for capturing carbon dioxide being arranged between the fuel-consuming apparatus and a turbocharger, a turbine of which is designed to be powered by the exhaust fumes and a compressor of which is designed to supply the fuel-consuming apparatus with oxidizer.

The present invention relates to the field of engines powered by natural gas, in particular engines for propelling or driving an accessory that is provided on a ship capable of containing and/or transporting liquefied natural gas, or engines provided on a gas terminal.

Such ships thus conventionally comprise tanks that contain natural gas in the liquid state. Natural gas is liquid at temperatures below-160° C. at atmospheric pressure. These tanks are never perfectly thermally insulated so that the natural gas at least partially evaporates therein. Thus, these tanks comprise both natural gas in liquid form and natural gas in gaseous form. This natural gas in gaseous form forms the top of the tank and the pressure in this top of the tank has to be controlled so as not to damage the tank. In a known manner, at least a portion of the natural gas present in the tank in gaseous form is thus used to power, inter alia, the propulsion engines of the ship.

These engines consume natural gas and emit exhaust fumes. For example, these exhaust fumes can be sent to the turbine of a turbocharger in order to drive a shaft of this turbocharger, which itself is rotatably connected to the compressor of the turbocharger. This compressor is then designed to compress air and supply the engine with the air thus compressed.

The exhaust fumes emitted by these engines are then released into the atmosphere. These exhaust fumes resulting from the combustion of natural gas supplied to the engine contain a high concentration of carbon dioxide. This carbon dioxide is then emitted to the atmosphere along with the rest of the exhaust fumes.

It is now known that carbon dioxide is one of the main air pollutants and new standards are gradually being put in place to force shipowners to significantly reduce these carbon dioxide emissions. The present invention falls within this context by providing a device for treating exhaust fumes which is suitable for being installed on a ship as defined above and which makes it possible to reduce the level of carbon dioxide in these exhaust fumes.

An object of the present invention thus relates to a device for treating at least a portion of the exhaust fumes emitted by at least one fuel-consuming apparatus, for example a ship, the treatment device comprising at least one compression member designed to raise a pressure of at least a portion of the exhaust fumes emitted by the fuel-consuming apparatus, and at least one unit for capturing carbon dioxide present in the exhaust fumes, the compression member and the unit for capturing carbon dioxide being arranged between the fuel-consuming apparatus and a turbocharger, a turbine of which is designed to be powered by the exhaust fumes and a compressor of which is designed to supply the fuel-consuming apparatus with oxidizer.

In other words, it is understood that the device for treating exhaust fumes according to the invention makes it possible to treat at least a portion of the fumes emitted by the fuel-consuming apparatus before they are reused to rotate the turbocharger and thus to supply the fuel-consuming apparatus with oxidizer. Advantageously, such a device thus makes it possible to capture carbon dioxide from the exhaust fumes at a time when said fumes have the highest concentration of carbon dioxide. As a result, the equipment used, and in particular the unit for capturing carbon dioxide, has the smallest possible dimensions, and therefore a limited bulk.

The fuel may be liquefied petroleum gas, heavy fuel oil, ultra-low sulfur fuel oil, diesel, methanol, leaded or unleaded gasoline, or a cryogenic fluid, such as liquefied natural gas or liquefied petroleum gas, that is stored in a tank, for example of a ship provided with the device for treating fumes and the fuel-consuming apparatus as described in the present document.

According to a feature of the invention, the device for treating exhaust fumes comprises at least one cooling means designed to cool the exhaust fumes emitted by the fuel-consuming apparatus, upstream of the unit for capturing carbon dioxide, and at least one heating means designed to heat the exhaust fumes downstream of the capture unit. The terms “upstream” and “downstream” are understood here with respect to the direction of movement of the exhaust fumes. In other words, the cooling means is designed to cool the fumes loaded with carbon dioxide and the heating means is designed to heat the fumes from which carbon dioxide has been unloaded. Advantageously, the cooling means and the heating means can operate jointly, that is to say that the heat present in the exhaust fumes loaded with carbon dioxide are used to heat the exhaust fumes from which this carbon dioxide has been unloaded, which makes it possible, simultaneously, to cool the fumes loaded with carbon dioxide.

Advantageously, the device for treating exhaust fumes according to the invention is designed to reduce the concentration of CO₂ in the exhaust fumes by up to 80%, and advantageously to a level of 40%. In other words, the treatment device according to the invention is designed such that the exhaust fumes emitted to the atmosphere have a carbon dioxide concentration 40% lower than the carbon dioxide concentration in the exhaust fumes leaving the fuel-consuming apparatus.

According to a first embodiment of the invention, the unit for capturing carbon dioxide comprises an absorption device suitable for at least a portion of the exhaust fumes leaving the compression member to pass therethrough, this absorption device being arranged on a solvent circuit in which a solvent designed to capture the carbon dioxide present in said exhaust fumes circulates. According to a feature of this first embodiment, the solvent circuit may comprise at least the absorption device, a member for circulating the solvent, at least one member for regenerating the solvent designed to allow the solvent to unload the captured carbon dioxide, at least a first heat exchanger designed to exchange heat between the solvent loaded with carbon dioxide and the solvent from which this carbon dioxide has been unloaded, and at least a second heat exchanger designed to cool the solvent upstream of the absorption device with respect to a direction of circulation of the solvent in the solvent circuit.

For example, the solvent can comprise amines, amine salts, sodium hydroxide solution, bicarbonate solution or alkaline solution. By way of example, this solvent may comprise one of the following components or a mixture thereof: monoethanolamine (MEA), aminoethylethanolamine (AEEA), sodium hydroxide (NaOH), hydrogen sulfite (H₂SO₃), diethanolamine (DEA), diethylenetriamine (DETA), aminomethyl propanol (TEA), methyldiethanolamine (MDEA) and piperazine (PZ). Advantageously, the regeneration member is designed such that the carbon dioxide unloaded therein can be recovered in liquid form. The carbon dioxide is then stored in a liquid state and at high pressure.

According to a second embodiment, the unit for capturing carbon dioxide comprises at least one refrigerant circuit on which are arranged at least a first heat exchanger suitable for exchanging heat between the refrigerant and gas taken from a tank, for example of a ship, in the liquid state, and at least a second heat exchanger suitable for exchanging heat between the refrigerant cooled by its passage through the first heat exchanger and the at least a portion of the exhaust fumes.

The result of the heat exchange which takes place within the second heat exchanger is icing of the carbon dioxide in the second heat exchanger. In order to recover carbon dioxide, the heat exchanger is closed so that its temperature rises at least to the liquefaction temperature of carbon dioxide. The carbon dioxide can then be stored in the liquid state and at high pressure, similarly to what is mentioned above with reference to the first embodiment.

The invention also relates to a system for supplying at least one fuel-consuming apparatus, for example a gas transport ship, with gas, the supply system comprising at least one tank containing a gas in the liquid state and in the gaseous state, at least one line for supplying the fuel-consuming apparatus with gas, at least one turbocharger designed to supply the fuel-consuming apparatus with oxidizer, and at least one device for treating fumes as mentioned above, the gas supply line comprising at least one heat exchanger designed to evaporate the gas taken from the tank in the liquid state and at least one compression device suitable for raising the pressure of the gas to a pressure compatible with the needs of the fuel-consuming apparatus.
The present invention also relates to a method for treating exhaust fumes emitted by a fuel-consuming apparatus using at least one device for treating exhaust fumes as mentioned above, the method comprising at least the steps of:

separating the exhaust fumes emitted by the fuel-consuming apparatus into a first portion of the exhaust fumes and a second portion of the exhaust fumes;
supplying the compression member with the first portion of the exhaust fumes;
compressing the first portion of the exhaust fumes by means of the compression member;
supplying the unit for capturing carbon dioxide with the first portion of the compressed exhaust fumes;
recovering the carbon dioxide present in the first portion of the exhaust fumes by means of the unit for capturing carbon dioxide;
mixing the first portion of the exhaust fumes leaving the unit for capturing carbon dioxide with the second portion of the exhaust fumes to form mixed fumes;
supplying the turbocharger with the mixed fumes;
cooling the mixed fumes leaving the turbocharger; and
emitting the cooled mixed fumes to the atmosphere.

According to a feature of the method for treating fumes according to the invention, the second portion of the exhaust fumes and the first portion of the exhaust fumes are different from each other.

For example, the first portion of the exhaust fumes represents between 10% and 90% of all of these exhaust fumes, and for example 50% of these exhaust fumes, while the second portion of the exhaust fumes represents between 90 and 10% of all of these exhaust fumes, and for example 50% of these exhaust fumes.

The first portion of the exhaust fumes and the second portion of the exhaust fumes can be added together to form the exhaust fumes emitted by the fuel-consuming apparatus.

The present invention further relates to a ship for transporting liquefied gas, comprising at least one fuel-consuming apparatus and at least one device for treating at least a portion of the exhaust fumes emitted by the fuel-consuming apparatus, as mentioned above.

The present invention finally relates to a system for loading or unloading a liquid gas, the system combining at least one onshore facility and at least one ship for transporting liquid gas as mentioned above.

The invention also relates to a method for loading or unloading a liquid gas from a ship as mentioned above.

Other features, details and advantages of the invention will emerge more clearly from reading the description which follows and from an embodiment given for illustrative purposes and without limitation with reference to the appended drawings, in which:

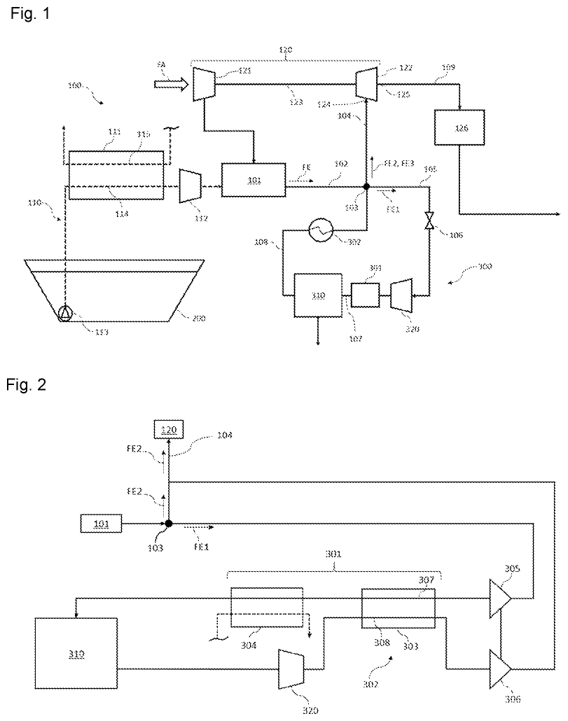

FIG. 1 schematically shows a system for supplying at least one fuel-consuming apparatus according to the invention with gas, the system comprising at least one device for treating exhaust fumes according to the present invention;

FIG. 2 schematically shows the gas supply system shown in FIG. 1 according to an alternative embodiment of the invention;

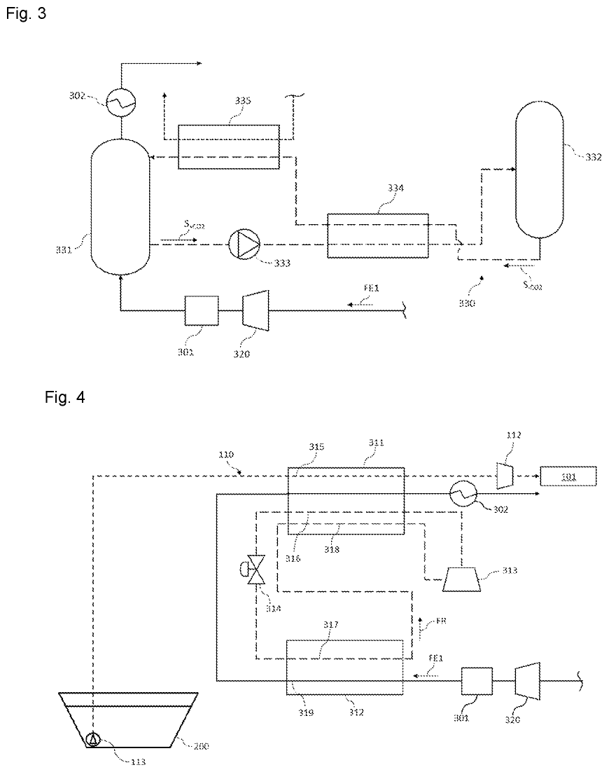

FIG. 3 schematically shows a first embodiment of the device for treating exhaust fumes shown in FIG. 1;

FIG. 4 schematically shows a second embodiment of the device for treating exhaust fumes shown in FIG. 1;

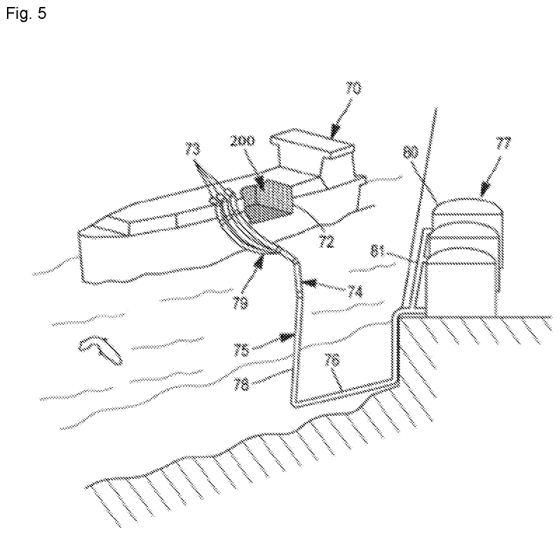

FIG. 5 is a cut-away schematic illustration of an LNG ship tank and of a terminal for loading and/or unloading this tank.

In the remainder of the description, the terms “upstream” and “downstream” are understood according to a direction of circulation of a fluid in the liquid, gaseous or two-phase state through the element in question.

FIG. 1 schematically shows a system 100 for supplying at least one fuel-consuming apparatus 101 with gas, the system comprising a device 300 for treating exhaust fumes emitted by the at least one fuel-consuming apparatus 101, while FIGS. 3 and 4 schematically show the device 300 for treating exhaust fumes according to a first embodiment of the invention and a second embodiment of the invention, respectively. As shown, the supply system 100 comprises at least one tank 200 which contains the fuel, for example a gas intended to be supplied to the at least one fuel-consuming apparatus 101, the gas being contained in this tank 200 in the liquid state and in the gaseous state. The following description gives a particular example of application of the present invention in which the tank 200 contains liquefied natural gas, liquefied petroleum gas, heavy fuel oil, ultra-low sulfur fuel oil, diesel, methanol or leaded or unleaded gasoline. It is understood that this is only an example of application and that the fuel supply system 100 according to the invention can be used with different types of liquid or gaseous fuel, for example hydrocarbon or hydrogen gases. Likewise, the figures show systems for supplying fuel to one fuel-consuming apparatus, but it is understood that the system could be suitable for supplying two or more gas-consuming apparatuses without departing from the context of the invention.

Thus, the fuel supply system described in this document can be a gas supply system. Throughout this document, the fuel-consuming apparatus can be considered as a gas-consuming apparatus.

In the remainder of the description, unless otherwise indicated, the term “fuel-consuming apparatus” designates one or more gas-consuming appliance(s). Furthermore, the terms “system 100” and “fuel system 100” are used interchangeably, as are the terms “exhaust fumes emitted by the fuel-consuming apparatus,” “exhaust fumes” and “fumes,” as well as the terms “fuel-consuming apparatus 101” and “apparatus 101.” In the figures, the dashed lines represent portions of the circuit in which gas drawn from the tank or a refrigerant circulates, and the solid lines represent portions of the circuit in which the exhaust fumes emitted by the fuel-consuming apparatus circulate.

FIG. 1 thus shows a supply system 100 according to the invention, comprising at least the tank 200 which contains gas in the liquid state and in the gaseous state, at least one gas supply line 110 of the fuel-consuming apparatus 101, at least one turbocharger 120, and at least one device 300 for treating fumes which comprises at least one unit 310 for capturing carbon dioxide (carbon dioxide being hereinafter designated by the symbol “CO₂”), at least one cooling means 301, at least one heating means 302, and at least one compression member 320. According to the examples shown, the compression member 320 is arranged upstream of the unit 310 for capturing CO₂. In other words, according to these examples, the exhaust fumes undergo an increase in their pressure before reaching this capture unit 310. Alternatively, the compression member 320 could be positioned downstream of this unit for capturing CO₂. In any event, this compression member 320 makes it possible to compensate for the pressure drops linked to the capture of CO₂ by means of the treatment device 300.

The cooling means 301 makes it possible to reduce the temperature of the exhaust fumes before they reach the capture unit 310. According to the examples shown, this cooling means 301 is arranged between the compression member 320 and the capture unit 310, but it is understood that this is only an example implementation of the invention and that the positions of these components could for example be reversed without departing from the context of the present invention. The heating means 302 is, according to the example shown in FIG. 1, arranged downstream of the capture unit 310 and its function will be more fully explained below. FIG. 2 shows an alternative embodiment of the system 100 which differs from what is described below, in particular on account of the arrangement of the cooling means 301, the compression member 320 and the heating means 302 with respect to the unit 310 for capturing CO₂.

The supply line 110 comprises at least one heat exchanger 111 designed to evaporate gas taken from the tank 200 in the liquid state and at least one compression device 112 designed to raise the pressure of the gas leaving the heat exchanger 111 to a pressure compatible with the needs of the fuel-consuming apparatus 101. In other words, the gas leaving the supply line 110 is in the gaseous state and has a pressure compatible with the needs of the fuel-consuming apparatus 101.

The example shown shows a situation in which the gas is taken from the tank 200 in the liquid state. To this end, at least one pump 113 is arranged in the bottom of the tank 200, that is to say the pump 113 is immersed in the gas present in the liquid state in this tank 200. The heat exchanger 111 comprises at least a first pass 114 and at least a second pass 115 and this heat exchanger 111 is designed to exchange heat between a fluid circulating in its first pass 114 and a fluid circulating in its second pass 115.

As shown, the gas taken from the tank 200 in the liquid state is supplied to the first pass 114 of the heat exchanger 111. The fluid circulating in the second pass 115 of this heat exchanger 111 is then selected such that an exchange of heat between this fluid and the gas in the liquid state results in evaporation of this gas in the liquid state. For example, the fluid that circulates in the second pass 115 can be sea water taken from near the ship provided with the system 100 according to the invention. The gas circulating in the first pass 114 thus captures heat from the sea water circulating in the second pass 115 such that this gas evaporates and leaves the first pass 114 in the gaseous state. The gas in the gaseous state then reaches the compression device 112 in which it undergoes compression, that is to say an increase in its pressure in order to reach a pressure compatible with the needs of the fuel-consuming apparatus 101.

According to an example not shown here, the gas can be taken from the tank in the gaseous state, in which case the heat exchanger is designed to increase the temperature of this gas, without said gas changing state. The heated gas then reaches the compression device as described above with reference to the example shown.

According to the examples shown, the fuel-consuming apparatus 101 requires an air supply. This fuel-consuming apparatus 101 can be a propulsion engine, for example of a ship provided with the system 100 according to the invention. In order to allow the fuel-consuming apparatus 101 to be supplied with oxidizer, the system 100 comprises the turbocharger 120. This turbocharger 120 comprises at least one compressor 121 designed to draw in an air flow FA and compress it, that is to say increase its pressure, before sending it to be supplied to the apparatus 101 and to power at least one turbine 122, which for its part is designed to rotate a shaft 123 rotatably connected to the compressor 121. Advantageously, the turbine 122 is powered by exhaust fumes emitted by the fuel-consuming apparatus 101. In other words, the fuel-consuming apparatus 101 consumes gas taken from the tank 200 and emits, at the outlet, exhaust fumes which are then used to power the turbine 122, this turbine 122 in turn moving the shaft 123 which rotates the compressor 121, which can thus compress air to be supplied to the fuel-consuming apparatus 101.

The exhaust fumes leaving the turbocharger 120 are then released into the atmosphere.

According to the embodiments shown in the figures, the exhaust fumes emitted by the fuel-consuming apparatus 101 have a pressure of approximately 3 bar. For example, these fumes can escape from the apparatus 101 at a pressure of 3.5 bar. It is understood that this is only an example and that these exhaust fumes could have a pressure greater than or less than 3 bar without departing from the context of the present invention.

In order to limit the impact of the system 100 on the environment, said system further comprises the device 300 for treating exhaust fumes. As mentioned above, this treatment device 300 comprises the cooling means 301, the heating means 302, the compression member 320, and the unit 310 for capturing CO₂. The components of the capture unit 310 are explained in detail below and differ according to the embodiment implemented.

A method for treating fumes which implements the system 100 according to the invention, and more particularly which implements the device 300 for treating fumes according to the invention, will now be described.

The operation of the supply line 110 has been described above and is not repeated in detail here. The exhaust fumes FE emitted by the fuel-consuming apparatus 101 take a first duct 102 which extends between the fuel-consuming apparatus 101 and a connection point 103 from which at least a second duct 104 and a third duct 105 extend, the third duct 105 carrying at least one flow control member 106. Here, the term “flow control member” means any member capable of controlling the flow of fumes in the duct carrying said flow.

The second duct 104 extends between the connection point 103 and the turbocharger 120, and more particularly between the connection point 103 and an inlet 124 of the turbine 122 of this turbocharger 120. The third duct 105 extends between the connection point 103 and the treatment device 300. According to the example shown, this third duct 105 extends more particularly between the connection point 103 and the compression member 320. This compression member 320 is connected, by means of a fourth duct 107 which extends from this compression member 320 and up to the capture unit 310, to the unit 310 for capturing CO₂, and this fourth duct 107 carries the cooling means 301. The heating means 302 is arranged on a fifth duct 108 which extends between the capture unit 310 and the connection point 103.

A sixth duct 109 finally extends between an outlet 125 of the turbine 122 and an environment external to the system 100, and this sixth duct 109 carries at least one member 126 for cooling the exhaust fumes. This cooling member 126 is thus designed to cool the exhaust fumes before releasing them into the atmosphere.

The exhaust fumes FE emitted by the fuel-consuming apparatus 101 which arrive at the connection point 103 are split in two due to the flow control member 106. Thus, this flow control member 106 allows a first portion FE1 of the exhaust fumes FE to take the third duct 105 while a second portion FE2 of the exhaust fumes is forced to take the second duct 104. According to the invention, the second portion FE2 of the fumes FE is different from the first portion FE1 of these exhaust fumes FE. For example, the second portion FE2 represents 90% to 10%, and in particular 50%, of all the exhaust fumes FE and the first portion FE1 represents between 10% and 90%, for example 50%, of all the exhaust fumes FE, it being possible to add the first portion FE1 and the second portion FE2 together to represent 100% of the exhaust fumes.

Thus, half of the fumes FE emitted by the fuel-consuming apparatus 101 are directed directly to the inlet 124 of the turbine 122 while the other half are directed to the device 300 for treating fumes. In other words, only half of the exhaust fumes are treated by the device 300 for treating fumes. Advantageously, this makes it possible to reduce the size of the elements which make up the device 300 for treating fumes, and therefore the overall dimensions of this device 300 for treating fumes.

The first portion of the exhaust fumes FE1 takes the third duct 105 and reaches the compression member 320 and the cooling means 301, in which these fumes undergo an increase in their pressure and a decrease in their temperature. As mentioned above, the fumes FE escape from the fuel-consuming apparatus 101 at a pressure of approximately 3.5 bar. According to the example shown, the compression member 320 is then designed to increase the pressure of the first portion of the fumes FE1 up to a pressure of approximately 4.5 bar. The first portion of the fumes FE1 at high pressure and at reduced temperature then reaches the unit 310 for capturing CO₂ in which at least a portion of the CO₂ that these fumes contain is unloaded from said fumes. For example, this unit 310 for capturing CO₂ is designed to retain 80% of the CO₂ present in this first portion of the fumes FE1. These fumes, from which a large portion of the CO₂ has been unloaded, then take the fifth duct 108 which extends between the capture unit 310 and the connection point 103. Along this fifth duct 108, the first portion of the fumes FE1 passes through the heating means 302 and the temperature thereof increases. The first portion of the fumes FE1 then reaches the connection point 103, at which this first portion of the fumes FE1, from which CO₂ has been unloaded, reaches and mixes with the second portion of the fumes FE2 emitted by the fuel-consuming apparatus 101. The mixture thus produced of the second portion of the fumes FE2 and of the first portion of the fumes FE1 from which CO₂ has been unloaded is then used to power the turbine 112 of the turbocharger 121, that is to say this mixture takes the second duct 104 to inlet 124 of the turbine 112. In the remainder of the description, the fumes which circulate in this second duct 104 are thus called “mixed fumes FE3.”

It is understood from the foregoing that the mixed fumes FE3 which circulate in the second duct 104 have a CO₂ level lower than the CO₂ level present in the exhaust fumes FE emitted by the fuel-consuming apparatus, that is to say the exhaust fumes FE which circulate in the first duct 102. According to the example shown, the mixed fumes FE3 have a CO₂ level that is 40% lower than the CO₂ level present in the fumes FE emitted by the apparatus 101 and circulating in the first duct 102.

These mixed fumes FE3 depleted in carbon dioxide can then be directed toward the cooling member 126 in order to be cooled and then released into the atmosphere.

FIG. 2 shows an alternative embodiment of the system 100 shown in FIG. 1 in which the operation of the cooling means 301 and the operation of the heating means 302 depend on one another. In order to facilitate understanding of the figure, only the device 300 for treating fumes is shown in detail in this figure (FIG. 2).

As shown, the treatment device 300 according to this alternative embodiment comprises at least a first heat exchange means 303, at least a second heat exchange means 304, at least the unit 310 for capturing CO₂, and at least the compression member 320.

The first portion of the fumes FE1 thus initially reaches the first heat exchange means 303, then the second heat exchange means 304, before reaching the unit 310 for capturing CO2. The first portion of the fumes FE1 from which CO₂ has been unloaded then reaches the compression member 320 before passing again through the first heat exchange means 303, then reaching the second duct 104 as described above.

In particular, the first heat exchange means 303 here takes the form of a heat exchanger which comprises at least a first pass 307 in which the fumes loaded with CO₂ circulate and at least a second pass 308 in which the fumes from which CO₂ has been unloaded circulate. The first heat exchange means 303 thus makes it possible to exchange heat between the fumes loaded with CO₂ and the fumes from which CO₂ has been unloaded, which results in a rise in the temperature of the fumes from which CO₂ has been unloaded and a decrease in the temperature of the fumes loaded with CO2. The heated fumes can thus be remixed, in the second duct 104, with the fumes which are emitted by the fuel-consuming apparatus 101 and which are not treated by the device 300 for treating fumes. The fumes loaded with

CO₂ are, for their part, partially cooled and reach the second heat exchange means 304, which is designed to exchange heat between these partially cooled fumes and sea water so as to cool the fumes further and thus allow them to be treated by the capture unit 310. For example, it is possible for the fumes to reach the unit 310 for capturing CO₂ at a temperature of approximately 35° C., while they arrive at the inlet of the first heat exchange means 303 at a temperature of approximately 350° C.

As previously mentioned, the passage through the unit 310 for capturing CO₂ causes a pressure drop which must be compensated for before the fumes from which CO₂ has been unloaded are returned to the second duct 104. Thus, according to this alternative, the compression member 320 is arranged downstream of the unit 310 for capturing CO₂ with respect to a direction of circulation of the fumes within the treatment device 300.

Thus, it is understood that the cooling means 301 is, according to the alternative shown in FIG. 2, provided by the first heat exchange means 303 and by the second heat exchange means 304 while the heating means 302 is provided by the first heat exchange means 303. The compression member 320 also participates in raising the temperature of the fumes from which CO₂ has been unloaded by raising their pressure. Such an arrangement thus makes it possible to use the heat carried by the fumes directly, without having to supply external energy to the device 300 for treating the fumes.

Optionally, a flow separator 305 can be arranged upstream of the first heat exchange means 303 with respect to a direction of circulation of the fumes loaded with CO₂, and a flow mixer 306 can be arranged downstream of this first heat exchange means 303 with respect to a direction of circulation of the fumes from which CO₂ has been unloaded.

With reference to FIGS. 3 and 4, two embodiments of the device 300 for treating fumes will now be described, with FIG. 3 showing the treatment device 100 according to a first embodiment and FIG. 4 showing the treatment device 100 according to a second embodiment.

According to the first embodiment, CO₂ is captured using a solvent, whereas according to the second embodiment the capture unit makes it possible to carry out what is known as “cryogenic” capture. In other words, the first embodiment differs from the second embodiment on account of the elements which make up the capture unit 310. According to other embodiments (not shown), CO₂ is captured by a membrane process, by non-chemical absorption, that is to say without solvent, or by adsorption.

According to the first embodiment shown in FIG. 3, the unit 310 for capturing CO₂ thus comprises a solvent circuit 330, that is to say a circuit 330 in which solvent circulates, the compression member 320, the cooling means 301, and the heating means 302. FIG. 3 shows an embodiment in which the cooling means 301, the heating means 302, and the compression member 320 are provided according to the example shown in FIG. 1, but it is understood that they could be arranged as described and shown in the alternative shown in FIG. 2 without departing from the context of the present invention.

The solvent circuit 330 comprises at least one absorption device 331 designed to extract CO₂ from the exhaust fumes, at least one regeneration member 332 designed to extract CO₂ from the solvent, at least one member 333 for circulating the solvent, at least a first heat exchanger 334 designed to exchange heat between the solvent S_{+CO2} loaded with carbon dioxide and the solvent S_{-CO2} from which this carbon dioxide has been unloaded, and at least a second heat exchanger 335 designed to cool the solvent upstream of the absorption device 331, that is to say the solvent from which CO₂ has been unloaded.

Thus, the first portion of the exhaust fumes FE1 reaches, initially, the absorption device 331, within which it is brought into contact with the solvent circulating in the solvent circuit 330. The solvent is selected for its ability to react with the carbon dioxide present in the fumes so as to extract this CO₂ from these fumes. The first portion of the exhaust fumes FE1 thus leaves the absorption device 331 with a portion of its CO₂ unloaded therefrom. According to the invention, the device 300 for treating fumes is more particularly designed such that the first portion of the fumes FE1 leaves the absorption device with approximately 80% of the CO₂ that it carries unloaded therefrom. For example, the solvent can comprise amines, amine salts, sodium hydroxide solution, bicarbonate solution or alkaline solution. By way of example, this solvent may comprise one of the following components or a mixture thereof: monoethanolamine (MEA), aminoethylethanolamine (AEEA), sodium hydroxide (NaOH), hydrogen sulfite (H₂SO₃), diethanolamine (DEA), diethylenetriamine (DETA), aminomethyl propanol (TEA), methyldiethanolamine (MDEA) and piperazine (PZ).

The solvent S_{+CO2} loaded with CO₂ leaves the absorption device 331 to reach the first heat exchanger 334. This solvent S_{+CO2} then reaches the regeneration member 332, in which it unloads the CO₂ captured in the absorption device 331. The solvent S_{-CO2} from which this carbon dioxide has been unloaded leaves the regeneration member 332 to reach, again, the first heat exchanger 334, in which it exchanges heat with the solvent S_{+CO2} loaded with CO₂. As a result of this heat exchange, the solvent S_{+CO2} loaded with CO₂ is heated while the solvent S_{-CO2} from which CO₂ has been unloaded is cooled. The regeneration member 332 is, for its part, suitable for allowing CO₂ to be recovered in the liquid state in order to allow its storage. More specifically, the CO₂ is recovered in liquid form then compressed to be stored at high pressure.

The cooled, unloaded solvent S_{-CO2} then reaches the second heat exchanger 335, in which it undergoes cooling again. For example, this second heat exchanger 335 can be designed to exchange heat between the unloaded solvent _{-CO2}, cooled by its passage through the first heat exchanger 334, and sea water. It is understood that this is only an embodiment and that the sea water could be replaced by any known refrigerant compatible with the invention without departing from the context of this invention. In any case, the solvent circuit 330, and more generally the device 300 for treating fumes, is designed such that the fumes and the unloaded solvent _{-CO2} reach the absorption device 331 at equivalent temperatures. For example, the fumes and the unloaded solvent S_{-CO2} can have a temperature of approximately 35° C. at the inlet of the absorption device 331.

The solvent S_{-CO2} from which CO₂ has been unloaded and which has been cooled can then reach, again, the absorption device 331 and restart a cycle on the solvent circuit 330.

FIG. 4 finally shows the device 300 for treating fumes according to the second embodiment of the invention. As mentioned previously, the capture of CO₂ according to the second embodiment is carried out by freezing CO₂. In other words, this second embodiment consists in cooling at least a portion of the exhaust fumes to a temperature at which the CO₂ becomes solid. At the pressures involved, this temperature is approximately −125° C.

To this end, the unit 310 for capturing CO₂ comprises at least a first heat exchanger 311 designed to exchange heat between gas taken from the tank 200 in the liquid state and a refrigerant FR, and at least a second heat exchanger 312 designed to exchange heat between the first portion of the exhaust fumes FE1 and the refrigerant FR. As shown, the first heat exchanger 311 and the second heat exchanger 312 are arranged on a refrigerant circuit FR, which further comprises at least one compression means 313 designed to raise the pressure of the refrigerant

FR and at least one expansion means 314 designed to reduce the pressure of this refrigerant FR. Thus, the first heat exchanger 311 comprises at least a first pass 315 which participates in forming the supply line 110 of the fuel-consuming apparatus 101 and at least a second pass 316 through which the refrigerant FR passes.

It is understood from the foregoing that the first heat exchanger 311 has the same function as the heat exchanger of the supply line described above with reference to FIG. 1, namely that of allowing gas taken from the tank 200 in the liquid state to be evaporated in order to be supplied to the fuel-consuming apparatus 101. The first heat exchanger 311 thus differs from the heat exchanger described previously in that it is designed to exchange heat between the refrigerant FR and the gas taken from the tank 200 rather than between the gas taken from the tank 200 and sea water.

The treatment device 300 according to this second embodiment also comprises the cooling means 301 and the heating means 302. The example shown in FIG. 4 repeats the arrangement described with reference to FIG. 1 but it is understood that the cooling means 301 and the heating means 302 could be arranged according to the example shown and described with reference to FIG. 2 without departing from the context of the present invention.

The term “refrigerant” is understood here to mean any fluid designed to capture, exchange and carry heat by changing state. Thus, the refrigerant FR reaches the compression means 313 in the gaseous state and at low pressure and leaves it in the gaseous state and at high pressure. The refrigerant FR then reaches the first heat exchanger 311, and more particularly the second pass 316 of this first heat exchanger 311, in which it yields heat, in particular to the gas circulating in the first pass 315, so that this refrigerant condenses. The refrigerant FR then reaches the expansion means 314 within which it undergoes a reduction in its pressure. The refrigerant thus reaches the second heat exchanger 312 in the liquid or two-phase state and at low pressure, and more particularly a first pass 317 of this second heat exchanger 312. Within this second heat exchanger 312, the refrigerant captures heat so that it evaporates and leaves this second heat exchanger 312 in the gaseous state and at low pressure to reach, again, the compression means 313 and start a new cycle. Advantageously, the refrigerant FR can, as shown in FIG. 4, pass back through the first heat exchanger 311, and more particularly through a third pass 318 of this first heat exchanger 311, before reaching the compression means 313. Thus, the second pass 315 and the third pass 318 of this first heat exchanger 311 form an internal heat exchanger which makes it possible to precool the refrigerant upstream of the expansion means 315, that is to say the refrigerant circulating in the second pass 316, and to preheat the refrigerant upstream of the compression means 313, that is to say the refrigerant circulating in the third pass 318 of this first heat exchanger 311.

The terms “low pressure” and “high pressure” are understood here relative to one another, that is to say the term “low pressure” means “pressure lower than high pressure.” The terms “upstream” and “downstream” are understood with respect to a direction of circulation of the refrigerant FR within the refrigerant circuit.

The first portion of the exhaust fumes FE1 initially reaches, for its part, the second heat exchanger 312, and more particularly a second pass 319 of this second heat exchanger 312, in which it transfers heat to the refrigerant FR so to evaporate this refrigerant and cool the fumes FE1. The device 300 for treating exhaust fumes is designed such that the cooling carried out within this second heat exchanger 312 is sufficient to cause solidification of the CO₂ present in the first portion of the fumes FE1. In particular, the CO₂ ices in the second heat exchanger 312 so that the fumes which leave this second heat exchanger have a CO₂ level which is 40% lower than the rate that these same fumes had upstream of the second heat exchanger 312. The fumes from which CO₂ has been unloaded then reach the first heat exchanger 311, and more particularly a fourth pass 410 of this first heat exchanger 311, in which it captures the heat emitted by the refrigerant FR so as to heat these fumes and condense the refrigerant FR. The fumes from which CO₂ has been unloaded can then be heated by the heating means 302 and then re-mixed with the second portion of the exhaust fumes which, for its part, is sent directly to the turbocharger as mentioned above.

Finally, the second heat exchanger 312 can be turned off, so that its temperature increases and thus the CO₂ present in the iced state in this second heat exchanger 312 can melt in order to be recovered then stored in the liquid state and at high pressure.

Finally, FIG. 5 is a cut-away view of a ship 70 which shows the tank 200 containing the gas in the liquid state and in the gaseous state, this tank 200 being of generally prismatic shape and mounted in a double hull 72 of the ship. This tank 200 can be part of an LNG carrier but it can also be a reservoir when the gas is used as fuel for the fuel-consuming apparatus.

The wall of the tank 200 has a primary sealing membrane intended to be in contact with the gas in the liquid state contained in the tank, a secondary sealing membrane arranged between the primary sealing membrane and the double hull 72 of the ship 70, and two insulating barriers respectively arranged between the primary sealing membrane and the secondary sealing membrane and between the secondary sealing membrane and the double hull 72.

Loading and/or unloading pipes 73 arranged on the upper deck of the ship can be connected, by means of suitable connectors, to a maritime or port terminal in order to transfer the cargo of gas in the liquid state from or to the tank 200, this gas being, for example, liquefied natural gas, liquefied petroleum gas, heavy fuel oil, ultra-low sulfur fuel oil, diesel, methanol or leaded or unleaded gasoline.

FIG. 5 also shows an example of a maritime terminal having a loading and/or unloading station 75, an underwater duct 76 and an onshore facility 77. The loading and/or unloading station 75 is a fixed offshore facility having a moving arm 74 and a tower 78 that supports the moving arm 74. The moving arm 74 carries a bundle of insulated pipes 79 that can be connected to the loading and/or unloading pipes 73. The adjustable moving arm 74 adapts to all ship sizes. The loading and unloading station 75 allows the loading and/or unloading of the ship 70 from or to the onshore facility 77. Said facility has liquefied gas storage tanks 80 and connecting ducts 81 connected by the underwater duct 76 to the loading or unloading station 75. The underwater duct 76 allows the transfer of the liquefied gas between the loading or unloading station 75 and the onshore facility 77 over a long distance, for example 5 km, which makes it possible to keep the ship 70 a long distance from the coast during loading and/or unloading operations.

In order to generate the pressure necessary for the transfer of the liquefied gas, an unloading pump or unloading pumps carried by the tower for loading and/or unloading the tank 200 and/or pumps provided in the onshore facility 77 and/or pumps provided in the loading and unloading station 75 are used.

Of course, the invention is not limited to the examples that have just been described, and numerous modifications can be made to these examples without departing from the scope of the invention.

The present invention thus provides a device for treating exhaust fumes emitted by a fuel-consuming apparatus, in particular a gas-consuming apparatus, of a ship, such as a propulsion engine of this ship, which device makes it possible to significantly reduce the concentration of carbon dioxide present in these exhaust fumes before releasing them into the atmosphere.

The present invention cannot, however, be limited to the means and configurations described and shown here, and it also extends to any equivalent means or configuration as well as to any combination technically using such means. In particular, the shape and arrangement of the cooling means, of the heating means, and of the compression member can be modified without detracting from the invention as long as they fulfill the functions described in this document.

1. A device for treating at least a portion of the exhaust fumes emitted by at least one fuel-consuming apparatus, the treatment device comprising at least one compression member designed to raise a pressure of at least a portion of the exhaust fumes emitted by the fuel-consuming apparatus, and at least one unit for capturing carbon dioxide present in the exhaust fumes, the compression member and the unit for capturing carbon dioxide being arranged between the fuel-consuming apparatus and a turbocharger, a turbine of which is designed to be powered by the exhaust fumes and a compressor of which is designed to supply the fuel-consuming apparatus with oxidizer.

2. Treatment The treatment device according to claim 1, comprising at least one cooling means designed to cool the exhaust fumes emitted by the fuel-consuming apparatus, upstream of the unit for capturing carbon dioxide, and at least one heating means designed to heat the exhaust fumes downstream of the capture unit.

3. The treatment device according to claim 1, wherein it is designed to reduce the concentration of carbon dioxide in the exhaust fumes emitted by the fuel-consuming apparatus by up to 80%.

4. The treatment device according to claim 1, wherein the unit for capturing carbon dioxide comprises an absorption device suitable for the at least a portion of the exhaust fumes leaving the compression member to pass therethrough, this absorption device being arranged on a solvent circuit in which a solvent (S+CO2, S−CO2) designed to capture the carbon dioxide present in said exhaust fumes circulates.

5. The treatment device according to claim 4, wherein the solvent circuit comprises at least the absorption device, a member for circulating the solvent, at least one member for regenerating the solvent designed to allow the solvent to unload captured carbon dioxide, at least a first heat exchanger designed to exchange heat between the solvent loaded with carbon dioxide (S+CO2) and the solvent from which this carbon dioxide (S−CO2) has been unloaded, and at least a second heat exchanger designed to cool the solvent (S−CO2) upstream of the absorption device with respect to a direction of circulation of the solvent in the solvent circuit.

6. The treatment device according to claim 1, wherein the unit for capturing carbon dioxide comprises at least one refrigerant circuit on which are arranged at least a first heat exchanger suitable for exchanging heat between the refrigerant and gas taken from a tank in the liquid state, and at least a second heat exchanger suitable for exchanging heat between the refrigerant cooled by its passage through the first heat exchanger and the at least a portion of the exhaust fumes.

7. A system for supplying at least one fuel-consuming apparatus with gas, the supply system comprising at least one tank containing a gas in the liquid state and in the gaseous state, at least one line for supplying the fuel-consuming apparatus with gas, at least one turbocharger designed to supply to the fuel-consuming apparatus with oxidizer, and at least one device for treating fumes according to claim 1, the gas supply line comprising at least one heat exchanger designed to evaporate the gas taken from the tank in the liquid state and at least one compression device suitable for raising the pressure of the gas to a pressure compatible with the needs of the fuel-consuming apparatus.

8. A method for treating exhaust fumes emitted by a fuel-consuming apparatus using at least one device for treating exhaust fumes according to claim 1, the method comprising at least the steps of:
separating the exhaust fumes emitted by the fuel-consuming apparatus into a first portion of the exhaust fumes and a second portion of the exhaust fumes;
supplying the compression member with the first portion of the exhaust fumes;
compressing the first portion of the exhaust fumes by means of the compression member;
supplying the unit for capturing carbon dioxide with the first portion of the compressed exhaust fumes;
recovering the carbon dioxide present in the first portion of the exhaust fumes by means of the unit for capturing carbon dioxide;
mixing the first portion of the exhaust fumes leaving the unit for capturing carbon dioxide with the second portion of the exhaust fumes to form mixed fumes;
supplying the turbocharger with the mixed fumes;
the mixed fumes leaving the turbocharger; and
emitting the cooled mixed fumes to the atmosphere.

9. The method for treating exhaust fumes according to claim 8, wherein the first portion of the exhaust fumes and the second portion of the exhaust fumes are different from each other.

10. The method for treating exhaust fumes according to claim 8, wherein the first portion of the exhaust fumes represents between 10% and 90% of all of these exhaust fumes, while the second portion of the exhaust fumes represents between 90% and 10% of all of these exhaust fumes.

11. A ship for transporting liquefied gas, comprising at least one fuel-consuming apparatus and at least one device for treating at least a portion of the exhaust fumes emitted by the fuel-consuming apparatus according to claim 1.

12. A System for loading or unloading a liquid gas, the system combining at least one onshore facility and at least one ship for transporting liquid gas according to claim 11.

13. A method for loading or unloading liquid gas from a gas transport ship according to claim 11.
